(19) United States
(12) Patent Application Publication
(10) Pub. No.: US 2012/0207835 A1
(43) Pub. Date: Aug. 16, 2012

(54) BROAD-SPECTRUM BIOCIDE COMPOSITIONS AND A METHOD FOR THEIR PREPARATION

(75) Inventors: Evgeny Shapiro, Haifa (IL); Chen Zolkov, Kiryat Tivon (IL); Rimma Khodakovskaya, Haifa (IL); Reinhard Effenberger, Haifa (IL)

(73) Assignee: BROMINE COMPOUNDS LTD., Beer-Sheva (IL)

(21) Appl. No.: 13/503,524

(22) PCT Filed: Oct. 18, 2010
(86) PCT No.: PCT/IL10/00848

§ 371 Date: Apr. 23, 2012

Related U.S. Application Data
(60) Provisional application No. 61/255,889, filed on Oct. 29, 2009.

(51) Int. Cl. A01N 25/00; A01P 1/00; A01N 59/06; A01N 59/00; A01N 59/16

(52) U.S. Cl. 424/484; 424/600; 424/617; 424/692; 424/724

(57) ABSTRACT

The present invention provides biocide compositions, containing DBNPA encapsulated or absorbed in ceramic powders or xerogels, for preventing the formation of biofilms and for incorporating into paints, coatings, plasters, and plastics.

### FIELD OF THE INVENTION

The present invention relates to biocide compositions. More specifically, the present invention relates to biocide compositions, a method for producing them, for disinfecting water, for preventing biofilm accumulation, and for incorporating into paints, coatings, plasters, plastics, and other industrial materials.

### BACKGROUND OF THE INVENTION

It is known that 2,2-dibromo-3-nitrilopropionamide (DBNPA) is a broad-spectrum biocide for controlling the growth of bacteria, fungi, yeast, cyanobacteria and algae [see, for example, U.S. Pat. No. 4,800,082 and U.S. Pat. No. 4,241,080].

However, the anti-fungal activity of DBNPA is less pronounced than its anti-bacterial activity. Another negative aspect of the DBNPA application is its corrosivity to tissue and its ability to cause skin sensitization, which requires that special precautions be taken to prevent the direct contact of personnel with the biocide (see MSDS). In addition, DBNPA is readily decomposed in aqueous media and loses its activity in 2-3 days at room temperature [see, e.g., Journal of Agricultural and Food Chemistry, vol. 21, 838-842 (1973)].

In attempts to overcome these drawbacks of DBNPA, several methods were described. For instance, U.S. Pat. No. 4,800,082 describes coating DBNPA by a hydrophilic polymer for both to prevent direct contact of personnel with the biocide and to provide for slow release of the biocide into the aqueous medium. WO 98/25458 relates to coating of tablets. US Appl. 2008/0004189 describes special effervescent materials to deliver biocides—including DBNPA—to fluids. EP 1322600 claims DBNPA in granular, tablet, briquette and pellet forms.

All these formulations are targeted to specific applications and are rarely used in other areas. For instance, DBNPA coated by a hydrophilic polymer and the DBNPA containing effervescent tablets cannot be used as in-can preservatives for aqueous paints as well as coatings and plastics. In addition, all these compositions contain components which are not necessarily compatible with the regular fillers used in paints, coatings and plastics. Compacted DBNPA free from binders or fillers is known but cannot be used for applications where fine powder is required.

### SUMMARY OF THE INVENTION

The invention provides a biocide composition comprising 2,2-dibromo-3-nitrilopropionamide (DBNPA) and a synergistic amount of at least one component selected from the group consisting of fine ceramic powders, silicon oxide, titanium oxide, magnesium oxide, and xerogels comprising alkoxysilanes. Said composition exhibits an enhanced antifungal activity when compared to DBNPA alone. In a preferred embodiment, said biocide composition comprises DBNPA and an amount of a xerogel derived from methyltrimethoxysilane (MTMOS). In another preferred embodiment, said biocide composition comprises alkoxysilane doped with titanium isopropoxide (TIPO) or with a fine powder of magnesium trisilicate (MTS). In a preferred aspect of the invention, said biocide composition comprises a binder, for example alginate.

The invention relates to a method for preparing a broad-spectrum biocide composition, comprising steps of i) preparing an essentially clear solution of DBNPA; ii) contacting said DBNPA with a component selected from MTS and TIPO; and iii) contacting said DBNPA with water either before or after said step ii). In a preferred method of the invention, said DBNPA solution is prepared by dissolving DBNPA in a material selected from alkoxysilane or acetonitrile. In a preferred embodiment of the invention, the method for preparing a broad-spectrum biocide composition comprises the formation of gel. The method further preferably comprises a step of drying said gel.

A preferred method of preparing the biocide composition according to the invention comprises steps of i) preparing a mixtures of DBNPA, an alkoxysilane, TIPO or MTS, and, optionally, organic solvent; ii) treating the mixture with water to induce hydrolysis of the alkoxysilanes; iii) aging the mixture to complete the formation of an inorganic glassy gel; iv) drying the formed gel to afford a solid powder-like xerogel; v) washing the xerogel with water to remove remaining free (non-encapsulated) DBNPA; vi) finally drying the wet composition; and grinding the solid composition to afford a fine powder of the final formulated DBNPA; thereby obtaining DBNPA encapsulated in an inorganic matrix.

The invention provides a method of disinfecting aqueous volumes or surfaces or interfaces, comprising contacting said volumes or surfaces or interfaces with a biocide composition comprising DBNPA and a component selected from alkoxysilanes-derived xerogels, ceramic powders, silicon oxide, titanium oxide, and magnesium oxide. The term “aqueous volumes or surfaces or interfaces” means such volumes and surfaces and interfaces which are in contact with mixtures containing water. In a preferred embodiment of the method according to the invention, said composition is incorporated into paints, coatings, plasters, and plastics. In another preferred embodiment, said volumes or surfaces or interfaces to be disinfected comprise filters or cartridges. In a further preferred embodiment, said volumes or surfaces or interfaces to be disinfected comprise materials and devices employed in industrial drilling.

### BRIEF DESCRIPTION OF THE DRAWING

The above and other characteristics and advantages of the invention will be more readily apparent through the following examples, and with reference to the appended drawing, wherein:

FIG. 1 shows leaching DBNPA from compositions.

### DETAILED DESCRIPTION OF THE INVENTION

It has now been found that the antifungal activity of DBNPA can be remarkably increased and prolonged by the addition of some synergists, such as fine ceramic powders, silicon oxide and/or titanium oxide xerogels. These compositions contain only materials (oxides of Si, Ti, Mg) which are compatible with components of commercial paints, coatings, plastics, etc.

Thus, in one aspect the instant invention is a biocide composition which comprises DBNPA, a ceramic powder and, optionally, a gelating agent such as ammonium alginate in the presence of calcium chloride.

In another aspect the instant invention is a process for preparing an antimicrobial composition which comprises a step of encapsulation of DBNPA in an inorganic matrix. Such a process comprises the steps of:

i) preparing mixtures of DBNPA, alkoxysilane, another synergist, and, optionally, organic solvent;

ii) treating the mixture with water to induce hydrolysis of the alkoxysilanes;

iii) aging the mixture to complete the formation of an inorganic glassy gel;

iv) drying the formed gel to afford a solid powder-like xerogel;

v) washing the xerogel with water to remove remaining free (non-encapsulated) DBNPA;

vi) finally drying the wet composition; and

vii) grinding the solid composition to afford a fine powder of the final formulated DBNPA.

The invention relates to incorporating encapsulated DBNPA into solid matrices, followed by processing the surface of the resulting particles.

It was found that the anti-fungal activity of DBNPA is remarkably increased in the presence of synergists which, separately, are either not active against fungi or manifest only low anti-fungal activity. Examples of such synergists are xerogels obtained from the acidic hydrolysis of alkoxysilanes, mixed with titanium alkoxides or with magnesium silicate powders. The most preferable synergists are xerogels derived from methyltrimethoxysilane (MTMOS) doped with either titanium (IV) isopropoxide (TIPO) or with a fine powder of magnesium trisilicate (MTS). The amount of alkoxysilanes and titanium alkoxides is 1-10 parts based on DBNPA. More preferably, 7 parts of MTMOS and 1.2-2 parts of TIPO, or 7 parts of MTMOS and 0.7-10 parts of MTS, are used in these compositions.

The preparation of the compositions starts with a DBNPA and alkoxysilane solution. It was found that DBNPA readily dissolves in liquid alkoxysilanes affording clear solutions containing >20% DBNPA. The solubility of the biocide can be increased by heating and by the addition of organic solvents such as alcohols, ketones, halogenated hydrocarbons, nitriles, etc.

These solutions can then be mixed with synergists such as TIPO, MTS powder or MTS powder slurries prepared by mixing the MTS powder with water and binder—a 0.2-3% aqueous AMA (ammonium alginate) solution. The special feature of AMA is its ability to chelate multivalent ions such as Ca (2+). In this case Ca-ions can be added as an aqueous CaCl2 solution.

The acidic hydrolysis is carried out by the treatment of the aforementioned solutions or suspensions with de-ionized water at pH<7. The amount of water should be more than 4 moles per mole alkoxysilane to ensure complete hydrolysis of all the four functionalities. More preferably, 5-6 moles of water/mole silane are used. In the case of ceramic powder slurries, the amount of water in the slurry is included in the calculation.

The addition of water initiates the exothermic hydrolysis reaction which is accompanied by evolution of an alcohol and the formation of a homogenous liquid phase with pH 3-4. The process can be forced by the addition of a small amount of acid to adjust the pH to 2-3. Usually, dilute HCl is used for this purpose.

In time, the mixture in transformed into a glassy gel. The rate of gel formation depends on the temperature and the rate of removal of the solvents and the formed alcohol. To promote the gel formation, the mixture is aged at 30-50° C. with gradual removal of volatiles under reduced pressure. Under these conditions, the gel formation is mostly completed within 2-20 h and the initial glassy gel is transformed to a powder-like solid.

In the next stage, the solid is triturated with water at 40-45° C. to remove free DBNPA. The preferred amount of water is 10 parts per one part of the solid (weight).

The washed solid is then finally dried at 40-45° C., preferably under reduced pressure, and ground to afford the desired composition. The step of the washing can follow grinding. In this case, ground material with desired particle size distribution is washed with water and then dried.

Thus, the invention provides superior biocidal compositions, comprising DBNPA and a synergistic amount of at least one component selected from xerogels comprising alkoxysilanes, fine ceramic powders, silicon oxide, titanium oxide, magnesium oxide, or mixtures thereof, which is advantageously used in disinfecting aqueous volumes or interfaces, and in preventing biofilm formation or accumulation. Such biocidal compositions are, in one aspect, incorporated into paints, coatings, plasters, or plastic industrial compositions. In another aspect, said compositions may be utilized in treating devices employed in industrial filtrations, for example in treating filters or cartridges used in water purification. In still another aspect, said compositions are utilized in the drilling applications (comprising oil, gas, water), for example in treating injected fluids, proppants, and the like. More generally, the biocidal compositions comprising DBNPA and a synergistic amount of the above defined components may be very useful in oil and gas industry; not limited to the drilling step alone, said compositions may be employed in stimulation or fracturing stage where solid matrix is being injected into the drill.

The invention enables to prevent biofilm accumulation on surfaces or microbial contamination in aqueous volumes, comprising incorporating the described biocide composition according to the invention into paints, coatings, plasters, plastics for processing or treating surfaces, or mixtures for disinfecting industrial devices.

The invention relates to the use of a biocide composition comprising DBNPA and a component selected from alkoxysilanes-derived xerogels, ceramic powders, silicon oxide, titanium oxide, and magnesium oxide, in disinfecting aqueous volumes or surfaces or interfaces. Said use may comprise, for example, incorporating said composition into paints, coatings, plasters, industrial plastic compositions, or other compositions for processing or treating surfaces. Said aqueous volumes or surfaces or interfaces may comprise devices employed in industrial processes such as filtering, drilling, and others.

The invention provides a method of preventing biofilms accumulations on surfaces or microbial contaminations in aqueous volumes, comprising i) contacting said surfaces and volumes with the biocide compositions as described above, or ii) incorporating said biocide compositions into mixtures employed in treating or processing surfaces. In this context, the term surface, as well as the term volume, relates mainly to the surface or volume of spaces and devices employed in industrial processes.

An example of a preferred biocidal composition comprises DBNPA and a xerogel derived from alkoxysilane doped with TIPO or MTS, possibly mixed with a binder.

It should be noted that the following examples are intended only to illustrate certain preferred embodiments of the present invention. They are in no way intended to limit the scope of the invention, as set out in the claims.

The following are preferred embodiments of a process for producing a xerogel having biocide activity, according to the present invention:

### Example 1

### Composition 1

DBNPA (14.61 g, 0.059 mol) was dissolved in methyltrimethoxysilane (52.51 g, 0.38 mol) at 45° C. and mixed with titanium (IV) isopropoxide (22.29 g. 0.076 mol) to afford a clear, slightly colored (yellowish) solution. The solution was mixed with de-ionized water (41.32 g, 2.27 mol) which immediately induced a strong exothermic reaction accompanied by the release of low-boiling compounds (mainly methanol). The mixture (pH 3) was stirred for 20 min at 45-47° C. to form a gel. The gel (127.3 g) was evaporated at 45° C. bath and 200 mbar using a rotary evaporator. Vacuum was gradually increased vacuum to 67 mbar to facilitate the removal of MeOH and IPA. The wet xerogel (100.15 g) was aged overnight at 45° C. in an oven (without mixing) to complete the gel formation and, finally, dried for 2.5 h at 44° C./24 mbar using the rotary evaporator, to afford a white powder (70.06 g). The powder was mixed with de-ionized water (150 ml) and stirred for 1 h at 40-45° C. The hot mixture was filtered. The wet cake (79.26 g) was dried for 1 h at 50° C./12 mbar in the rotary evaporator, and for 3.5 h at 45° C. in the heating oven, to afford 57.20 g of the product as a slightly colored (yellowish) solid material. The solid was ground to afford 54.15 g of the product containing 5.3% Br, which corresponds to 8% DBNPA.

### Example 2

### Compositions 2a, 2b, and 2c

DBNPA (29.83 g, 0.121 mol) was dissolved in methyltrimethoxysilane (100.0 g, 0.719 mol) at 45° C., cooled to ambient temperature and mixed with titanium (IV) isopropoxide (42.22 g. 0.144 mol) to afford a clear, slightly colored (yellowish) substrate solution. Water (78.6 g 4.32 mol) was charged into a 1 L flask jointed to a rotary evaporator. The bath of the rotary evaporator was heated to 30° C. and vacuum of 200 mbar was adjusted. The reaction flask with water was immersed into the bath and stirring was activated. The substrate solution was added for 1 h by small portions to water, using vacuum, to afford white dispersion. The vacuum was gradually increased to 50 mbar for 1.5 h to facilitate the volatiles (methanol, 2-propanol, and, finally, water, total 85.8 g) to afford 133.7 g of a white product as aggregated powder-like solid. The wet solid (131.13 g) was dried overnight at 40° C./10 mbar in the heating oven without stirring to afford 93.15 g of the white solid.

The obtained white friable solid was easily ground in mortar and fractionated on three sieves (0.3 mm, 0.15 mm, and 0.045 mm) to afford 41.28 g of fraction with particle size within 0.15-0.3 mm (13.1% Br, 20% DBNPA), 25.8 g of fraction with particle size within 0.045-0.15 mm (15.9% Br, 24.1% DBNPA), and 8.4 g of the finest fraction with particle size <0.045 mm (26.9% Br, 40.7% DBNPA). Samples of the obtained xerogels (−5 g of each) were mixed with de-ionized water (10 parts per one part of the solid (weight) and stirred for 1 h at 40-45° C. The hot suspensions were filtered and wet cakes were finally dried at 45° C./2 mbar to afford respectively 5.84 g (composition 2a), 5.0 g (2b), and 4.74 g (2c) of a powder-like materials containing 7.3%, 8.1%, and 13.4% Br, corresponding to 11%, 12.3%, and 20.3% DBNPA.

### Example 3

### Composition 3

A magnesium trisilicate (MTS, MgSi₃O₇) ceramic powder slurry was obtained by mixing a fine powder of MTS (110 g, BET SSA 300 m²/g) with 1% ammonium alginate solution (AMA, 180 g).

The paste (26.00 g, 0.49 mol of MTS) was diluted with de-ionized water (17.35 g, 0.95 mol) and heated to 40-45° C., to afford a suspension with pH 8-9. A warm (45° C.) slightly turbid solution of DBNPA (12.55 g, 0.051 mol) in MTMOS (50.1 g, 0.36 mol) was added to the mixture, all-at-once, under stirring. The suspension was treated with 40% CaCl₂ brine (1.53 g, 0.0055 mol), followed by 10% HCl (2.6 g) to adjust the pH to 2-3. A strongly exothermic reaction started and the mixture became slightly colored and was transformed into a homogeneous suspension. The mixture was stirred for 2 h at 43-45° C. and evaporated in a 45° C. bath at 200 mbar using a rotary evaporator to facilitate the escape of MeOH. The formed gel was aged overnight at 40-45° C. under stirring, to complete the gel formation. The resulting xerogel was dried for 30 min at 45° C. and 92 mbar, using a rotary evaporator. Vacuum was gradually increased to 11 mbar to afford a wet colored powder. The solid was mixed with de-ionized water (150 ml) and stirred for 1 h at 40-45° C. The hot suspension was filtered. The wet cake was finally dried at 45° C./2 mbar to afford 36.07 g of a powder-like material which was ground in a mortar to yield a beige powder containing 6.68% Br, corresponding to 10% DBNPA.

### Example 4

### Composition 4

A fine powder of magnesium trisilicate (8.00 g, 0.036 mol, BET SSA 300 m²/g) was introduced into a warm (45° C.) slightly turbid solution of DBNPA (12.61 g, 0.051 mol) in MTMOS (50.25 g, 0.36 mol), under stirring. The resulting suspension was treated with de-ionized water (34.32 g, 1.89 mol) to afford a three-phase system with pH 8-9.10% HCl (−2 g) was added to adjust the pH to 2, which launched a strong exothermic reaction. The fine suspension obtained was aged for 2 h at 40-45° C., under stirring, and then concentrated to half its original volume at 45° C./200 mbar over 35 min, to facilitate the release of MeOH. The suspension was aged overnight at 40-45° C. under stirring, to complete the gel formation. The colored solid was finely dried at 45° C./11 mbar over 30 min and treated with de-ionized water (150 ml) for 1.25 h at 40-45° C. The hot suspension was filtered. The wet cake was finely dried at 45° C./2 mbar to afford 37.24 g of a solid material which was ground in a mortar to afford a light brown powder containing 8.3% Br, corresponding to 12.6% DBNPA.

### Example 5 (Comparative)

### Composition 5

A magnesium trisilicate ceramic powder slurry was obtained by mixing a fine powder of MgSi₃O₇ (56.4 g) with 0.3% AMA solution (AMA, 120 g).

The wet product (5.19 g) was dried in a 60° C. bath in a rotary evaporator, under reduced pressure (10 mbar) to afford 2.85 g of a white solid which was readily ground to a fine powder in a mortar.

### Example 6 (Comparative)

### Composition 6

A clear solution of DBNPA (15.84 g) and MTMOS (33.24 g) in acetonitrile (44.76 g) was treated with water (43.76 g). The initial two-phase system was transformed to a clear solution (pH 3) in 1 min as the result of an exothermic reaction. The mixture was treated with a 10% HCl (0.167 g) to adjust the pH to 2.5 and stirred overnight at 30° C. The turbid solution was concentrated to half its initial volume in a 51° C. bath rotary evaporator, under reduced pressure (150 mbar), to afford 46.23 g of a sticky solid. The mixture was triturated with water (50 ml) for 1 h at 30° C. The supernatant liquor was separated and the remaining solid was dried for 1.5 h in a 51° C. bath evaporator, under reduced pressure (5 mbar), to afford a solid. The composition was ground, to yield 26.22 g of a white powder containing 31.8% Br which corresponds to 48.2% DBNPA.

### Example 7

### Composition 7

A solution of DBNPA (18.81 g, 0.0762 mol) in acetonitrile (26.66 g, 0.643 mol) was added to a mixture of TEOS (50.0 g, 0.235 mol) and TIPO (16.57 g, 0.0565 mol) to afford a clear, slightly colored solution. The mixture was treated with de-ionized water (40.0 g, 2.2 mol) which immediately induced the precipitation of a voluminous white solid (pH 5). 10% HCl (0.96 g) was added to adjust the pH to 1.5. An exothermic reaction started and the initial gel was transformed into a stirrable suspension. The mixture was stirred for 2 h at 15-18° C., concentrated to ⅔ of its initial volume in a 40° C. bath evaporator at 92 mbar, and aged for 3.5 h at 45-47° C. without stirring, to complete the gel formation. The gel was dried by evaporation in a 40° C. bath evaporator at 15 mbar, to afford 73.09 g solid. The solid was triturated with de-ionized water (200 ml) for 1 h at 20-25° C. and filtered. The wet material was finally dried in a 51° C. bath rotary evaporator at 2 mbar, to afford 36.28 g of powder. The total Br content was 28.9% (44% DBNPA).

### Example 8 (Comparative)

### Composition 8

Example 7 was repeated using TEOS (50.52 g), TIPO (16.86 g), acetonitrile (29.40 g), de-ionized water (40.0 g), and 10% HCl (0.96 g), but no DBNPA was added to the reaction mixture. A white fine powder, 29.45 g, was obtained.

### Example 9

### Composition 9

TEOS (49.59 g, 0.233 mol) was added to a solution of DBNPA (15.10 g, 0.061 mol) in acetonitrile (42.60 g, 1.03 mol). The resulting clear solution was treated with de-ionized water (44.52 g, 2.45 mol), under stirring. A weakly exothermic reaction occurred in 1 min to yield a clear solution with pH 3. The solution was treated with 10% HCl (−0.2 g) to adjust the pH to 2.5, under stirring, and the reaction mixture was stirred overnight at 30° C. The clear solution was concentrated in a 51° C. bath rotary evaporator at 30 mbar. The amorphous solid, partially stuck to the walls, was mixed with de-ionized water (50 ml) and stirred for 1.25 h at 30° C. The supernatant liquor was decanted and the residue was dried at 51° C./5 mbar to afford 37.12 g of a white solid, which was readily ground in a mortar to a white powder. The total Br was 24.3%, corresponding to 36.8% DBNPA.

### Example 10 (Comparative)

### Composition 10

A clear solution of DBNPA (3.13 g) in acetonitrile (14 ml) was mixed with a suspension of a fine powder of MgO (15.70 g) in acetonitrile (8 ml). The mixture was stirred for 1 h, aged for 7 days at room temperature and filtered. The wet cake (24.52 g) was dried at 50° C./5 mbar using a rotary evaporator, to afford 17.18 g of powder, containing 7.5% Br.

The powder was triturated for 1 h at room temperature with water (51 g), filtered and dried at 60° C./10 mbar, to afford 5.3 g of a powder-like material containing <0.8% Br.

### Example 11 (Comparative)

### Composition 11

The procedure of Example 10 was repeated using a fine powder of amorphous silica gel (17.8 g), DBNPA (3.6 g), and acetonitrile (54 ml). The initial impregnate (8.0 g) containing 7.6% Br, after triturating with water (80 g), practically lost all the biocide (residual Br<0.8%).

### Example 12 (Comparative)

### Composition 12

Example 5 was repeated using 5.52 g of a magnesium trisilicate ceramic powder slurry which was mixed with a solution of DBNPA (1.1121 g) in acetonitrile (11 ml). The suspension was aged at room temperature for 7 days to afford a gel. The gel (13.83 g) was dried in a 60° C. bath rotary evaporator, under reduced pressure (400 mbar), to afford 6.36 g of a white powder containing 10% Br.

The powder was triturated with water (60 g) for 1 h at 20-25° C., then filtered and dried using a rotary evaporator at 60° C./90 mbar, to afford 5.05 g of a white powder containing 0.8% Br.

### Example 13 (Comparative)

### Composition 13

Example 7 was repeated using DBNPA (2.73 g), TIPO (20.0 g), acetonitrile (8.25 g) and water (3.0 g). The suspension was stored overnight at 20-25° C. and dried in a 60° C. bath rotary evaporator under reduced pressure, to afford 9.64 g of a white powder containing 16.1% Br.

The powder was triturated with water (51 g) for 1 h at 20-25° C., then filtered and dried using a rotary evaporator at 60° C./90 mbar, to afford 5.38 g of a white powder containing 1.65% Br.

### Bio-Test Data

Samples of the prepared materials were dispersed in hot (˜45° C.) agar, under stirring. The amount of DBNPA in the agar was 1000 or 300 ppm. The hot liquid suspension was poured into the Petri dish and cooled, to afford a solid agar gel containing the material being tested. The central part of the solid agar (ID 1 cm) was replaced by the same size of agar containing mold, A. niger. The dishes were incubated for 28 days, measuring the diameter of the fungal growth ring after 3, 7, 14, 21, and 28 days. Pure DBNPA and commercial biocide (OTW) were used as standards. All the results were duplicated to assure accuracy.

The data are presented in Table 1. General abbreviations are as follows:
TEOS—tetraethoxysilane;
MTMOS—methyl trimethoxysilane;
TIPO—tetraisopropoxysilane;
MeCN—acetonitrile;
AMA—ammonium alginate;
MTS—magnesium trisilicate;
OTW—N-octylisothiazolinone.

TABLE 1
A. niger diameters after contact with biocide matrix

| | | | | | A. niger diameters | | | | |
|---|---|---|---|---|---|---|---|---|---|
| | | | | | (cm) | | | | |
| | | Composition. | % | DBNPA in | Days | | | | |
| Example | Sample description | No. | Br | agar, ppm | 3 | 7 | 14 | 21 | 28 |
| 1 | DBNPA + MTMOS + 20% TIPO, | 1 | 5.3 | 300 | 1 | 1 | 1 | 1 | 1 |
| | water | | | | | | | | |
| 2 | DBNPA + MTMOS + 20% TIPO, | 2a | 7.3 | 300 | 1 | 1 | 1 | 1.1 | 1.1 |
| | water, particle size range 0.15-0.3 mm | | | | | | | | |
| 2 | DBNPA + MTMOS + 20% TIPO, | 2b | 8.1 | 300 | 1 | 1 | 1.6 | 4.2 | 7 |
| | water, particle size range 0.045-0.15 mm | | | | | | | | |
| 2 | DBNPA + MTMOS + 20% TIPO, | 2c | 13.4 | 300 | 1 | 1.4 | 10 | n/p | n/p |
| | water, particle size <0.045 mm | | | | | | | | |
| 3 | DBNPA + MTMOS + MTS + AMA/ | 3 | 6.7 | 300 | 1 | 1 | 1 | 1 | 1 |
| | CaCl₂, water | | | | | | | | |
| 4 | DBNPA + MTMOS + MTS, water | 4 | 8.3 | 300 | 1 | 1 | 1 | 1 | 1 |

Data on standards

| | | | | | | | |
|---|---|---|---|---|---|---|---|
| OTW neat | 0 | 300 | 1 | 1 | 1 | 1 | 1 |
| DBNPA (20% in PEG) | 20.0 | 300 | 3.7 | 10 | 10 | 10 | 10 |
| DBNPA (20% in PEG) | 20.0 | 1000 | 1 | 1 | 1 | 1 | 1 |

Data on comparative examples

| | | | | | | | | | |
|---|---|---|---|---|---|---|---|---|---|
| 5 | MTS, water | 5 | 0 | 0 | 5 | 10 | 10 | 10 | 10 |
| 6 | DBNPA + MTMOS, MeCN | 6 | 31.8 | 300 | 4.3 | 10 | 10 | 10 | 10 |
| 7 | DBNPA + TEOS + 24% TIPO, | 7 | 28.9 | 300 | 3.5 | 10 | 10 | 10 | 10 |
| | MeCN | | | | | | | | |
| 7 | DBNPA + TEOS + 24% TIPO, | 7 | 28.9 | 1000 | 1 | 1 | 1 | 1 | 1 |
| | MeCN | | | | | | | | |
| 8 | TEOS + 24% TIPO, MeCN | 8 | 0 | 0 | 5 | 10 | 10 | 10 | 10 |
| 9 | DBNPA + TEOS, MeCN | 9 | 24.3 | 300 | 3.4 | 10 | 10 | 10 | 10 |
| 9 | DBNPA + TEOS, MeCN | 9 | 24.3 | 1000 | 1 | 1 | 1 | 1 | 1 |
| 10 | DBNPA + MgO, MeCN | 10 | <0.8 | 0 | n/p | n/p | n/p | n/p | n/p |
| 11 | DBNPA + silica gel, MeCN | 11 | <0.8 | 0 | n/p | n/p | n/p | n/p | n/p |
| 12 | DBNPA + MTS, MeCN | 12 | 0.8 | n/p | n/p | n/p | n/p | n/p | n/p |
| 13 | DBNPA + TIPO, MeCN | 13 | 1.7 | n/p | n/p | n/p | n/p | n/p | n/p |
| | DBNPA + MTMOS + MTS + AMA/ | 13 | 3.2 | 300 | 1 | 1 | 1 | 1 | 1 |
| | CaCl₂, water, HCl, after 5 | | | | | | | | |
| | washes | | | | | | | | |

Note:
n/p—not performed

The data of Table 1 demonstrate the strong anti-fungal activity of the synergetic compositions 1, 2a, 3, and 4 at concentrations of 300 ppm DBNPA over more than 4 weeks. The activity is comparative to the activity of OTW. Neat DBNPA at this concentration loses activity over 3 days. It demonstrates activity only at concentrations of >1000 ppm. The separate, synergists, e.g. MTS (composition 5), taken in the same concentrations as DBNPA, are not active. Combinations without the synergist (e.g., DBNPA+MTMOS, combination 6) or combinations with TEOS instead of MTMOS (e.g. DBNPA+TEOS+TIPO, composition 8, or DBNPA+TEOS, combination 8) manifest the same level of activity as neat DBNPA at a concentration of 1000 ppm.

Comparison of data for compositions 2a, 2b, and 2c reveals remarkable effect of particle size on anti-fungal activity.

Compositions which do not contain xerogels obtained by the hydrolysis of MTMOS are unable to retain the DBNPA. Such compositions (e.g., DBNPA+MgO, composition 10, DBNPA+MTS, composition 12, DBNPA+TIPO, composition 13) lose the biocide in the stage of washing with water.

### Leaching Data

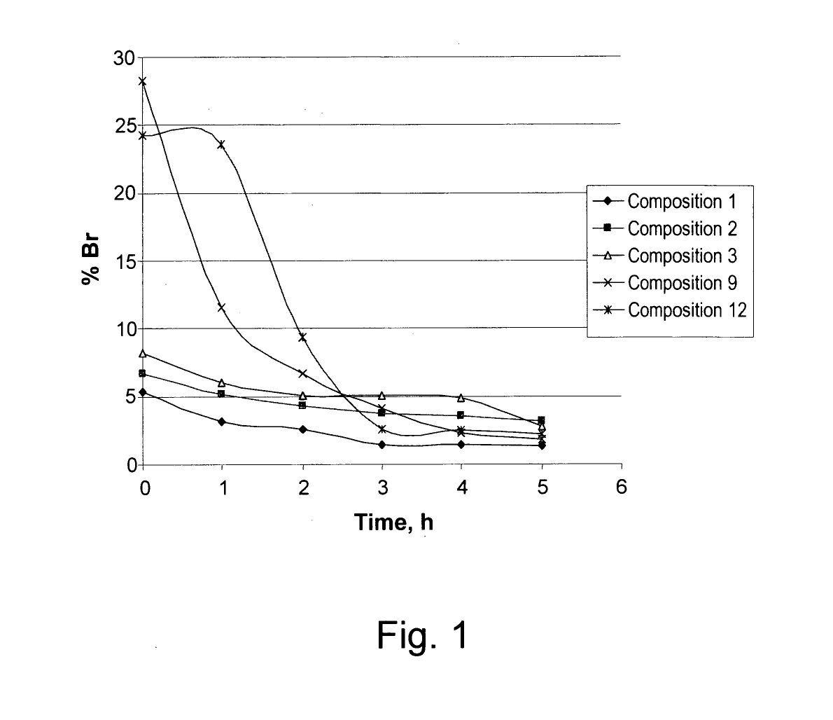

To determine the rate of release, compositions were triturated with de-ionized water (liquid/solid ratio ˜10 w/w) for 1 h at room temperature and filtered. Part of the wet composition (˜1-1.5 g) was taken off and dried at 50° C./2 mbar, and analyzed for total Br. The residual wet matrix was mixed with de-ionized water, maintaining approximately the same L/S ratio (but taking into consideration the reduction in the matrix weight) and the procedure was repeated. A total of 5 triturations were carried out. The data are presented in FIG. 1.

The data show that the DBNPA-doped compositions gradually release the biocides into the de-ionized water. The rate of release mainly depends on the alkoxysilane used. Compositions obtained from MTMOS release the biocide more slowly than those prepared from TEOS.

However, the compositions still retain bioactivity even after the 5-fold washing with de-ionized water. Data illustrating such behavior are collected in Table 1 for composition 13.

1. A biocide composition comprising 2,2-dibromo-3-nitrilopropionamide (DBNPA) and a synergistic amount of at least one component selected from the group consisting of fine ceramic powders, silicon oxide, titanium oxide, magnesium oxide, and xerogels comprising alkoxysilanes.

2. A biocide composition according to claim 1, exhibiting an enhanced antifungal activity when compared to DBNPA alone.

3. A biocide composition according to claim 1, comprising DBNPA and an amount of a xerogel derived from methyltrimethoxysilane (MTMOS).

4. A biocide composition according to claim 1, comprising a xerogel made from an alkoxysilane doped with titanium isopropoxide (TIPO) or with a fine powder of magnesium trisilicate (MTS).

5. A biocide composition according to claim 1, comprising a binder.

6. A biocide composition according to claim 1, comprising alginate as a binder.

7. A method for preparing a broad-spectrum biocide composition, comprising steps of
i) preparing an essentially clear solution of DBNPA;
ii) contacting said DBNPA with a component selected from MTS and TIPO; and
iii) contacting said DBNPA with water either before or after said step ii).

8. A method according to claim 7, wherein said solution is prepared by dissolving said DBNPA in a solvent comprising an alkoxysilane or acetonitrile.

9. A method according to claim 7, comprising the formation of gel, and optionally a step of drying said gel.

10. A method according to claim 7, comprising incorporating encapsulated DBNPA into solid matrices, followed by processing the surface of the resulting particles.

11. A method according to claim 7, comprising steps of
i) preparing a mixtures of DBNPA, an alkoxysilane, TIPO or MTS, and, optionally, organic solvent;
ii) treating the mixture with water to induce hydrolysis of the alkoxysilanes;
iii) aging the mixture to complete the formation of an inorganic glassy gel;
iv) drying the formed gel to afford a solid powder-like xerogel;
v) washing the xerogel with water to remove remaining free (non-encapsulated) DBNPA;
vi) finally drying the wet composition; and
vii) grinding the solid composition to afford a fine powder of the final, formulated DBNPA;
thereby obtaining DBNPA encapsulated in an inorganic matrix.

12. A method of disinfecting aqueous volumes or surfaces, comprising contacting said volumes or surfaces with a biocide composition according to claim 1.

13. A method according to claim 12, comprising incorporating said composition into paints, coatings, plasters, and plastics.

14. A method according to claim 12, wherein said volumes or surfaces comprise filters or cartridges.

15. A method according to claim 12, wherein said volumes or surfaces comprise materials and devices employed in industrial drilling, wherein said compositions are optionally employed in stimulation or fracturing stage where solid matrix is being injected into the drill.
